(19) United States
(12) Patent Application Publication
(10) Pub. No.: US 2013/0134326 A1
(43) Pub. Date: May 30, 2013

(54) EXTREME ULTRAVIOLET LIGHT GENERATION APPARATUS, TARGET COLLECTION DEVICE, AND TARGET COLLECTION METHOD

(71) Applicants: Takayuki Yabu, Hiratsuka-shi (JP); Youichi Sasaki, Hiratsuka-shi (JP); Yulaka Shiraishi, Hiratsuka-shi (JP); Shinji Nagai, Hiratsuka-shi (JP); Osamu Wakabayashi, Oyama-shi (JP)

(72) Inventors: Takayuki Yabu, Hiratsuka-shi (JP); Youichi Sasaki, Hiratsuka-shi (JP); Yulaka Shiraishi, Hiratsuka-shi (JP); Shinji Nagai, Hiratsuka-shi (JP); Osamu Wakabayashi, Oyama-shi (JP)

(21) Appl. No.: 13/595,312

(22) Filed: Aug. 27, 2012

(30) Foreign Application Priority Data
Nov. 24, 2011 (JP) 2011-256858
Jun. 14, 2012 (JP) 2012-134801

(51) Int. Cl. G21K 5/02; B65B 63/08

(52) U.S. Cl. 250/455.11; 53/127; 53/440

(57) ABSTRACT

A target collection device may include a collection container having an opening through which a target material is collected into the collection container, and a temperature adjuster configured to adjust a temperature of the collection container to a temperature that is equal to or higher than a melting point of the target material. The target collection device may be part of an extreme ultraviolet light generation apparatus. Methods of target collection are also provided.

### CROSS-REFERENCE TO RELATED APPLICATIONS

The present application claims priority from Japanese Patent Application No. 2011-256858 filed Nov. 24, 2011, and Japanese Patent Application No. 2012-134801 filed Jun. 14, 2012.

### BACKGROUND

1. Technical Field

This disclosure relates to an apparatus for generating extreme ultraviolet (EUV) light, a device for collecting a target, and a method for collecting the target.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed in which a system for generating Extreme Ultraviolet (EUV) light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used.

### SUMMARY

A target collection device according to one aspect of this disclosure may include a collection container having an opening through which a target material is collected into the collection container, and a temperature adjuster configured to adjust a temperature of the collection container to a temperature that is equal to or higher than a melting point of the target material.

An extreme ultraviolet light generation apparatus according to another aspect of this disclosure may include a chamber in which extreme ultraviolet light is generated, a target supply device configured to output a target material into the chamber, and the above-described target collection device.

A target collection method according to yet another aspect of this disclosure may include forming a liquid surface of a target material in a collection container for collecting the target material, and receiving the target material outputted from a target supply device at the liquid surface.

### BRIEF DESCRIPTION OF THE DRAWINGS

Hereinafter, selected embodiments of this disclosure will be described with reference to the accompanying drawings.

FIG. 1 schematically illustrates a configuration of an exemplary LPP type EUV light generation apparatus.

FIG. 2 schematically illustrates an exemplary configuration of an EUV light generation apparatus to which a target collection device according to a first embodiment is applied.

FIG. 3 schematically illustrates an exemplary configuration of a target generation unit.

FIG. 4 schematically illustrates an exemplary configuration of a target collection device.

FIG. 5 is a flowchart showing an exemplary operation of an EUV light generation apparatus in a case where a solid target material is present in a collection container.

FIG. 6 schematically illustrates an exemplary configuration of a target collection device according to a second embodiment.

FIG. 7 schematically illustrates an exemplary configuration of a target collection device according to a third embodiment.

FIG. 8 schematically illustrates an exemplary configuration of an EUV light generation apparatus according to a fourth embodiment, in which droplets are generated on-demand.

FIG. 9 schematically illustrates an exemplary configuration of the EUV light generation apparatus according to the fourth embodiment, in which droplets are generated in a continuous-jet method.

FIG. 10 schematically illustrates an exemplary configuration of an EUV light generation apparatus according to a fifth embodiment.

FIG. 11 schematically illustrates an exemplary configuration of a target collection device according to a sixth embodiment.

FIG. 12 is a flowchart showing an exemplary operation of an EUV light generation apparatus in a case where a solid target material is not present in a collection container but is present in a collection tank.

FIG. 13 schematically illustrates an exemplary configuration of a target collection device according to a seventh embodiment.

FIG. 14 is a flowchart showing an exemplary operation of an EUV light generation apparatus in a case where a solid target material is not present in a collection container but is present in a supply tank.

### DETAILED DESCRIPTION

Hereinafter, selected embodiments of this disclosure will be described in detail with reference to the accompanying drawings. The embodiments to be described below are merely illustrative in nature and do not limit the scope of this disclosure. Further, configurations and operations described in each embodiment are not all essential in implementing this disclosure. Note that like elements are referenced by like reference numerals and characters, and duplicate descriptions thereof will be omitted herein.

### Contents

### 1. Overview

### 2. Overview of EUV Light Generation System

### 2.1 Configuration

### 2.2 Operation

### 3. Embodiments of EUV Light Generation Apparatus

### 3.1 First Embodiment

### 3.1.1 Configuration

### 3.1.2 Operation

### 3.2 Second Embodiment

### 3.2.1 Configuration

### 3.2.2 Operation

### 3.3 Third Embodiment

### 3.3.1 Configuration

### 3.3.2 Operation

### 3.4 Fourth Embodiment

### 3.4.1 Configuration

### 3.4.2 Operation

### 3.5 Fifth Embodiment

### 3.5.1 Configuration

### 3.6 Sixth Embodiment

### 3.6.1 Configuration

### 3.6.2 Operation

### 3.7 Seventh Embodiment

### 3.7.1 Configuration

### 3.7.2 Operation

### 1. Overview

In one or more embodiments of this disclosure, a target collection device may be provided inside a chamber to collect a target material outputted from a target supply device. This target collection device may include a collection container, a container temperature adjuster, and a capacity adjuster. The collection container may have an opening through which the target material is collected into the collection container. The container temperature adjuster may be configured to control a temperature of the collection container to a temperature that is equal to or higher than the melting point of the target material. The capacity adjuster may be configured to discharge the target material from the collection container so that a fluid level of the target material in the collection container is retained within a predetermined range.

When a target material from a target supply device is collected into an empty collection container, the target material may solidify dendritically in the collection container. When a target material from a target supply device is collected into a collection container in which a solid target material is stored, the target material may also solidify dendritically in the collection container. When this dendritically-solidified metal sticks out of the collection container, EUV light may not be generated properly.

According to the above-described collection device, a temperature of the collection container is adjusted to be equal to or higher than the melting point of the target material, and a target material stored in the collection container may be kept in a liquid state. Then, the target material from the target supply device may be received at a surface of the liquid target material in the collection container. Accordingly, the target material from the target supply device may be taken into the liquid target material without solidifying dendritically in the collection container. Further, according to the above-described target collection device, the target material may be discharged from the collection container so that the amount of the target material in the collection container does not exceed a predetermined level. Thus, even when the EUV light generation apparatus is put in operation for a long period of time, the target material may not flow out of the collection container inside the chamber.

### 2. Overview of EUV Light Generation System

### 2.1 Configuration

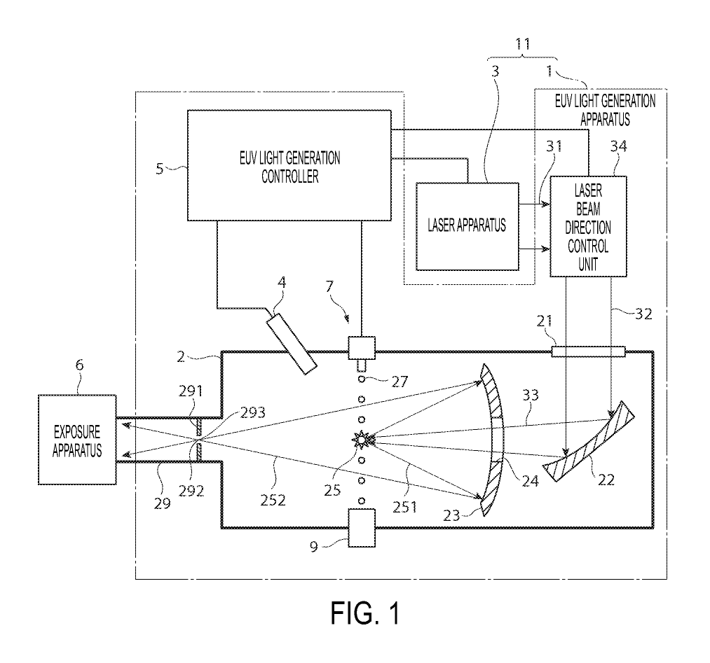

FIG. 1 schematically illustrates a configuration of an exemplary Laser Produced Plasma (LPP) type EUV light generation system. An EUV light generation apparatus 1 may be used with at least one laser apparatus 3. Hereinafter, a system that includes the EUV light generation apparatus 1 and the laser apparatus 3 may be referred to as an EUV light generation system 11. As illustrated in FIG. 1 and described in detail below, the EUV light generation system 11 may include a chamber 2 and a target supply device 7. The chamber 2 may be airtightly sealed. The target supply device 7 may be mounted on the chamber 2 so as to, for example, penetrate a wall of the chamber 2. A target material to be supplied by the target supply device 7 may include, but is not limited to, tin, terbium, gadolinium, lithium, xenon, or any combination thereof.

The chamber 2 may have at least one through-hole formed in its wall, and a pulse laser beam 32 may travel through the through-hole into the chamber 2. Alternatively, the chamber 2 may have a window 21, through which the pulse laser beam 32 may travel into the chamber 2. An EUV collector mirror 23 having a spheroidal surface may, for example, be provided inside the chamber 2. The EUV collector mirror 23 may have a multi-layered reflective film formed on the spheroidal surface thereof. The reflective film may include a molybdenum layer and a silicon layer being laminated alternately. The EUV collector mirror 23 may have a first focus and a second focus, and may be positioned such that the first focus lies in a plasma generation region 25 and the second focus lies in an intermediate focus (IF) region 292 defined by the specification of an external apparatus, such as an exposure apparatus 6. The EUV collector mirror 23 may have a through-hole 24 formed at the center thereof, and a pulse laser beam 33 may travel through the through-hole 24 toward the plasma generation region 25.

The EUV light generation system 11 may further include an EUV light generation controller 5 and a target sensor 4. The target sensor 4 may have an imaging function and detect at least one of the presence, the trajectory, and the position of a target 27. The EUV light generation controller 5 may be electrically connected to the laser apparatus 3 and the target supply device 7.

Further, the EUV light generation system 11 may include a connection part 29 that allows the interior of the chamber 2 and the interior of the exposure apparatus 6 to be in communication with each other. A wall 291 having an aperture 293 may be provided inside the connection part 29, and the wall 291 may be positioned such that the second focus of the EUV collector mirror 23 lies in the aperture 293 formed in the wall 291.

The EUV light generation system 11 may further include a laser beam direction control unit 34, a laser beam focusing mirror 22, and a target collection device 9 for collecting targets 27. The laser beam direction control unit 34 may include an optical element (not separately shown) for defining the direction into which the pulse laser beam 32 travels and an actuator (not separately shown) for adjusting the position and the orientation (posture) of the optical element.

### 2.2 Operation

With continued reference to FIG. 1, a pulse laser beam 31 outputted from the laser apparatus 3 may pass through the laser beam direction control unit 34 and be outputted therefrom as a pulse laser beam 32 after having its direction optionally adjusted. The pulse laser beam 32 may travel through the window 21 and enter the chamber 2. The pulse laser beam 32 may travel inside the chamber 2 along at least one beam path, be reflected by the laser beam focusing mirror 22, and strike at least one target 27 as a pulse laser beam 33.

The target supply device 7 may be configured to output the target(s) 27 toward the plasma generation region 25 inside the chamber 2. The target 27 may be irradiated with at least one pulse of the pulse laser beam 33. Upon being irradiated with the pulse laser beam 33, the target 27 may be turned into plasma, and rays of light including EUV light 251 may be emitted from the plasma. The EUV light 251 may be reflected selectively by the EUV collector mirror 23. EUV light 252, which is the light reflected by the EUV collector mirror 23, may travel through the intermediate focus region 292 and be outputted to the exposure apparatus 6. The target 27 may be irradiated with multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control at least one of the timing at which the target 27 is outputted, the direction into which the target 27 travels, and the speed at which the target 27 travels. Furthermore, the EUV light generation controller 5 may be configured to control at least one of the timing at which the laser apparatus 3 oscillates, the direction in which the pulse laser beam 32 travels, and the position at which the pulse laser beam 33 is focused. It will be appreciated that the various controls mentioned above are merely examples, and other controls may be added as necessary.

### 3. Embodiments of EUV Light Generation Apparatus

### 3.1 First Embodiment

### 3.1.1 Configuration

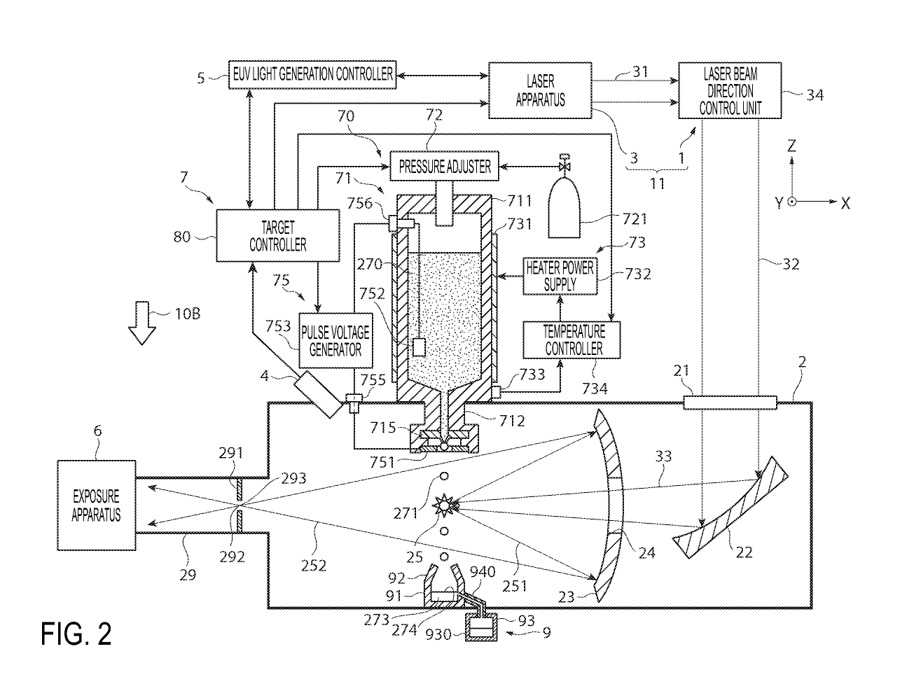

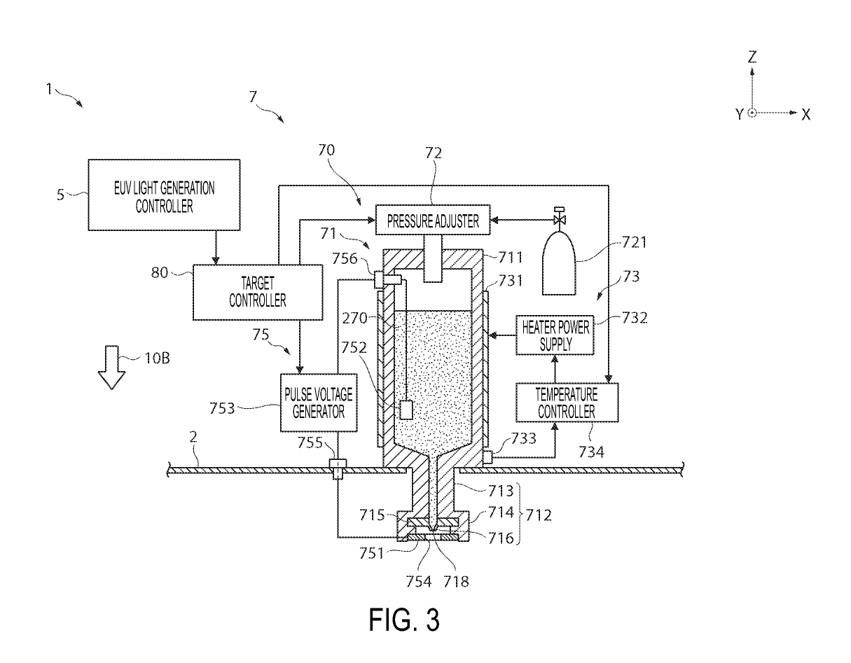

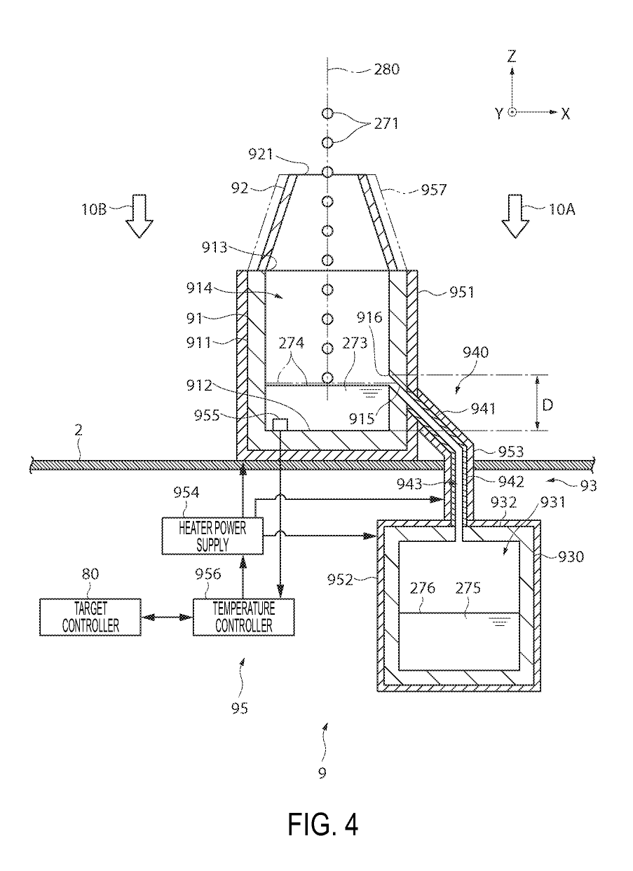

FIG. 2 schematically illustrates an exemplary configuration of an EUV light generation apparatus to which a target collection device according to a first embodiment is applied. FIG. 3 schematically illustrates an exemplary configuration of a target generation unit. FIG. 4 schematically illustrates an exemplary configuration of a target collection device.

As shown in FIG. 2, an EUV light generation apparatus 1 may include a chamber 2, a target supply device 7, and a target collection device 9. The target supply device 7 may include a target generation unit 70 and a target controller 80. The target controller 80 may be electrically connected to a laser apparatus 3 and an EUV light generation controller 5.

The target generation unit 70 may include a target generator 71, a pressure adjuster 72, a first temperature adjuster 73, and an electrostatic pull-out unit 75. The target generator 71 may include a tank 711 configured to store a target material 270 therein. The tank 711 may be cylindrical in shape. The tank 711 may include a nozzle 712, and the target material 270 stored in the tank 711 may be outputted into the chamber 2 through the nozzle 712 as a target material 271. The target generator 71 may be mounted onto the chamber 2 such that the tank 711 is located outside the chamber 2 and the nozzle 712 is located inside the chamber 2. The pressure adjuster 72 may be connected to the tank 711.

Depending on how the chamber 2 is installed, a direction in which the target material 271 is designed to travel may not coincide with the gravitational direction, and the target material 271 may be designed to travel in a direction inclined with respect to the gravitational direction. In the first embodiment, however, the chamber 2 may be installed so that the direction in which the target material 271 is designed to travel coincides with a gravitational direction 10B (see FIGS. 2 through 4).

As shown in FIG. 3 and with continued reference to FIG. 2, the nozzle 712 may include a nozzle body 713, a holding unit 714, and an output unit 715. The nozzle body 713 may be provided to project into the chamber 2 from the bottom surface of the tank 711. The holding unit 714 may be provided at a leading end of the nozzle body 713. The holding unit 714 may be cylindrical in shape and have an outer diameter larger than that of the nozzle body 713. The holding unit 714 may be formed separately from the nozzle 713 and fixed on the nozzle body 713.

The output unit 715 may be substantially disc-shaped. The output unit 715 may be held by the holding unit 714 to be in close contact with the leading end surface of the nozzle body 713. A frustoconical protrusion 716 may be formed at the center of the output unit 715 so that an electric field is enhanced at the protrusion 716. A nozzle opening 718 may be formed in the protrusion 716 at substantially the center thereof. The output unit 715 may be formed of a material having low wettability with the target material 270. Alternatively, the output unit 715 may be coated with a material having low wettability with the target material 270.

Each of the tank 711, the nozzle 712, and the output unit 715 may be formed of an electrically non-conductive material. Alternatively, when the tank 711, the nozzle 712, and the output unit 715 are formed of metal, such as molybdenum, an electrically non-conductive material may be provided between the chamber 2 and the target generator 71, and between the output unit 715 and a pull-out electrode 751 which will be described later. In this case, the tank 711 may be electrically connected to a pulse voltage generator 753 which will be described later.

An inert gas cylinder 721 may be connected to the pressure adjuster 72. The target controller 80 may be electrically connected to the pressure adjuster 72. The pressure adjuster 72 may be configured to adjust a pressure of an inert gas supplied from the inert gas cylinder 721, to thereby control a pressure inside the tank 711.

The first temperature adjuster 73 may be configured to control a temperature of the target material 270 in the tank 711. The first temperature adjuster 73 may include a first heater 731, a first heater power supply 732, a first temperature sensor 733, and a first temperature controller 734. The first heater 731 may be provided on an outer surface of the tank 711. The first heater power supply 732 may be electrically connected to each of the first heater 731 and the first temperature controller 734. The first heater power supply 732 may be configured to supply electric power to the first heater 731 based on a signal from the first temperature controller 734. Upon being supplied with electric power, the first heater 731 may emit heat. Thus, the target material 270 in the tank 711 may be heated.

The first temperature sensor 733 may be provided on the outer surface of the tank 711 at a position closer to the leading end thereof. Alternatively, the first temperature sensor 733 may be provided inside the tank 711. The first temperature controller 734 may be electrically connected to the first temperature sensor 733. The first temperature sensor 733 may determine a temperature of the target material 270 in the tank 711 by detecting a temperature of the tank 711, and send a signal corresponding to a determined temperature to the first temperature controller 734. The first temperature controller 734 may be configured to output a signal to the first heater power supply 732 to control a temperature of the target material 270 to a predetermined temperature based on the signal from the first temperature sensor 733. The first temperature controller 734 may be electrically connected to the target controller 80.

The electrostatic pull-out unit 75 may include the pull-out electrode 751, an electrode 752, and the pulse voltage generator 753. The pull-out electrode 751 may be substantially disc-shaped. The pull-out electrode 751 may have a circular through-hole 754 formed at the center thereof, through which a target material 271 (see FIG. 2) may pass. The pull-out electrode 751 may be held by the holding unit 714 such that a space is secured between the pull-out electrode 751 and the output unit 715. The pull-out electrode 751 may be positioned such that the axis of the through-hole 754 coincides with the axis of the protrusion 716. The pull-out electrode 751 may be electrically connected to the pulse voltage generator 753 through a first introduction terminal 755.

The electrode 752 may be provided inside the tank 711 to be in contact with the target material 270. The electrode 752 may be electrically connected to the pulse voltage generator 753 through a feedthrough 756. The pulse voltage generator 753 may be configured to apply a voltage between the pull-out electrode 751 and the target material 270 in the tank 711 through the electrode 752. The pulse voltage generator 753 may be electrically connected to the target controller 80.

As shown in FIG. 4 and with continued reference to FIG. 2, the target collection device 9 may include a collection container 91, a covering 92, a capacity adjuster 93, and a second temperature adjuster 95.

The collection container 91 may include a cylindrical side wall 911 and a bottom 912. An opening 913 may be defined at an end of the side wall 911 opposite to the bottom 912. The collection container 91 may be provided inside the chamber 2 such that the axis of the side wall 911 is aligned with a set output direction 10A of the target material 271 and with the gravitational direction 10B and such that the axis of the side wall 911 coincides with a trajectory 280 of the target material 271. The collection container 91 may be configured to be capable of storing the target material 271 in an internal space 914 as a target material 273.

The side wall 911 may have a through-hole 915 formed therein to extend obliquely as shown in FIG. 4. An opening 916 of the through-hole 915 may open into the internal space 914. The through-hole 915 may be formed such that a distance between an edge of the opening 916 located upward in the gravitational direction 10B and the upper surface of the bottom 912 is at a distance D. This configuration may allow a depth of the target material 273 stored inside the collection container 91, which is a distance between a liquid surface 274 of the target material 273 and the upper surface of the bottom 912, not to exceed the distance D.

The covering 92 may be frustoconical in shape with both ends open. The covering 92 may be provided on the side wall 911 such that the base side of the covering 92 is connected to the periphery of the opening 913. The covering 92 may be positioned such that the axis of the covering 92 coincides with the axis of the side wall 911. An opening 921 at the vertex side of the covering 92 may be sufficiently large with respect to a diameter of the target material 271.

The capacity adjuster 93 may be configured to discharge the target material 273 from the collection container 91 such that a fluid level of the target material 273 in the collection container 91 is retained within a predetermined range. The capacity adjuster 93 may include a collection tank 930 and a connection pipe 940 serving as a discharge pipe.

The collection tank 930 may be box-shaped having an internal space 931. The collection tank 930 may be provided outside the chamber 2.

The connection pipe 940 may have an internal space 943, which may allow the internal space 914 of the collection container 91 to be in communication with the internal space 931 of the collection tank 930 through the through-hole 915. The connection pipe 940 may include a first pipe 941 and a second pipe 942. The first pipe 941 may extend obliquely from the periphery of the through-hole 915, and the second pipe 942 may extend from the first pipe 941 to an upper surface 932 of the collection tank 930.

The second temperature adjuster 95 may be configured to control a temperature of the collection container 91, a temperature of the collection tank 930, and a temperature of the connection pipe 940. The second temperature adjuster 95 may include a container heater 951 serving as a container temperature adjuster, a tank heater 952, a pipe heater 953 serving as a pipe temperature adjuster, a second heater power supply 954, a second temperature sensor 955, and a second temperature controller 956.

The container heater 951 may be provided to cover the side wall 911 and the bottom 912. The tank heater 952 may be provided to cover the outer surface of the collection tank 930. The pipe heater 953 may be provided to cover the outer surface of the connection pipe 940. As indicated by two-dot-dashed lines in FIG. 4, a covering heater 957 may be optionally provided to cover the outer surface of the covering 92.

The second heater power supply 954 may be electrically connected to each of the container heater 951, the tank heater 952, the pipe heater 953, and the second temperature controller 956. The second heater power supply 954 may be configured to supply electric power to the container heater 951, the tank heater 952, and the pipe heater 953 based on signals from the second temperature controller 956. Upon being supplied electric power, each of the container heater 951, the tank heater 952, and the pipe heater 953 may emit heat. Thus, the target material 273 in the collection container 91, a target material 275 in the collection tank 930, and the inner surface the connection pipe 940 may be heated to a substantially uniform temperature. Here, when the covering heater 957 is provided, the second heater power supply 954 may also supply electric power to the covering heater 957 to cause the covering heater 957 to emit heat.

The second temperature sensor 955 may be provided on the upper surface of the bottom 912. The second temperature controller 956 may be electrically connected to the second temperature sensor 955. The second temperature sensor 955 may be configured to detect a temperature of the target material 273 in the collection container 91, and send a signal corresponding to a detected temperature to the second temperature controller 956. The second temperature controller 956 may be configured to determine a temperature of the target material 273 in the collection container 91 based on a signal from the second temperature sensor 955, and output a signal to the second heater power supply 954 to adjust electric power to be supplied to the container heater 951. The second temperature controller 956 may be electrically connected to the target controller 80.

### 3.1.2 Operation

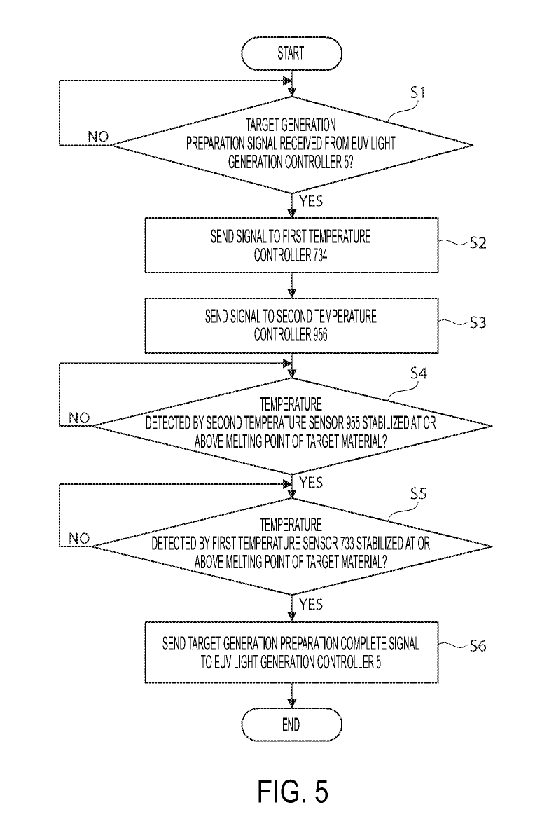

FIG. 5 is a flowchart showing an exemplary operation of an EUV light generation apparatus in a case where a solid target material is present in a collection container.

With reference to FIG. 5, in a state where a pressure inside the chamber 2 is adjusted to a pressure at which EUV light may be generated, the target controller 80 may determine whether or not a target generation preparation signal has been received from the EUV light generation controller 5 (Step S1). When the target generation preparation signal has not been received (Step S1; NO), Step S1 may be repeated.

On the other hand, when the target controller 80 receives the target generation preparation signal (Step S1; YES), the target controller 80 may send a signal to the first temperature controller 734 (Step S2). Based on this signal, the first heater power supply 732 may be controlled such that a temperature of the target material 270 in the tank 711 reaches or exceeds the melting point of the target material 270.

The melting point of tin is 232° C., the melting point of gadolinium is 1312° C., and the melting point of terbium is 1356° C.

More specifically, in Step S2, the first temperature controller 734 may determine a temperature of the target material 270 based on a signal from the first temperature sensor 733. Then, the first temperature controller 734 may control the first heater power supply 732 so that a temperature of the target material 270 reaches or exceeds its melting point. When the first temperature controller 734 determines that a temperature of the target material 270 is stabilized at a temperature that is equal to or higher than the melting point of the target material 270, the first temperature controller 734 may send a signal to the target controller 80.

Thereafter, the target controller 80 may send a signal to the second temperature controller 956 of the target collection device 9 (Step S3). Based on this signal, the second heater power supply 954 may be controlled such that a temperature of the target material 273 in the collection container 91, a temperature of the target material 275 in the collection tank 930, and a temperature inside the connection pipe 940 reach or exceed the melting point of the target material 273/275.

More specifically, in Step S3, the second temperature controller 956 may determine a temperature of the target material 273 in the collection container 91 based on a signal from the second temperature sensor 955. Then, the second temperature controller 956 may control electric power to be supplied to each of the container heater 951, the tank heater 952, and the pipe heater 953 such that a temperature of the target material 273 and a temperature of the target material 275 reach or exceed the melting point of the target material 273/275. When the second temperature controller 956 determines that a temperature of the target material 273 is stabilized at a temperature that is equal to or higher than the melting point of the target material 273, the second temperature controller 956 may send a signal to the target controller 80.

In this way, the collection container 91 may be heated such that a temperature of the target material 273 in the collection container 91 reaches or exceeds the melting point of the target material 273. Thus, the target material 273, which is stored in a solid state in advance, may melt. Further, since the connection pipe 940 is also heated as described above, a temperature inside the connection pipe 940 may reach or exceed the melting point of the target material 273, which may prevent the liquid target material 273 discharged from the collection container 91 from solidifying while passing through the internal space 943 of the connection pipe 940. In addition, since the collection tank 930 is also heated as described above, the liquid target material 273 collected into the collection tank 930 as the target material 275 may remain in a liquid state in the collection tank 930.

Accordingly, the liquid surface 274 of the target material 273 may be formed in the collection container 91 and a liquid surface 276 (see FIG. 4) of the target material 275 may be formed in the collection tank 930.

Here, Step S2 may be carried simultaneously with Step S3, or Step S2 may be carried out after Step S3.

The target controller 80 may then determine whether or not a temperature detected by the second temperature sensor 955 is stabilized at a predetermined temperature that is equal to or higher than the melting point of the target material 273 based on a signal from the second temperature controller 956 (Step S4). When a detected temperature is determined not to be stabilized (Step S4; NO), Step S4 may be repeated. This determination on whether or not the detected temperature is stabilized at a predetermined temperature may be made by determining whether or not a variation in a detected temperature falls within a predetermined temperature range for a predetermined period of time. This determination standard may also be applicable in cases where a similar determination is to be made in the description to follow.

On the other hand, when the target controller 80 determines that a detected temperature is stabilized (Step S4; YES), the target controller 80 may then determine whether or not a temperature detected by the first temperature sensor 733 is stabilized at a temperature that is equal to or higher than the melting point of the target material 270 based on a signal from the first temperature controller 734 (Step S5).

When the target controller 80 determines that a detected temperature is not stabilized (Step S5; NO), Step S5 may be repeated. When the target controller 80 determines that a detected temperature is stabilized (Step S5; YES), the target controller 80 may send a target generation preparation complete signal to the EUV light generation controller 5 (Step S6).

With reference to FIGS. 2 through 4, upon receiving the target generation preparation complete signal, the EUV light generation controller 5 may send a target generation signal to the target controller 80. Upon receiving the target generation signal, the target controller 80 may send a signal to the pressure adjuster 72 to adjust a pressure inside the tank 711. Upon receiving this signal, the pressure adjuster 72 may adjust a pressure inside the tank 711 so that the target material 271 is pressurized and is pushed out through the nozzle 712. Further, the target controller 80 may send a signal to the pulse voltage generator 753 to apply a voltage between the electrode 752 and the pull-out electrode 751.

When a voltage is applied between the electrode 752 and the pull-out electrode 751, the target material 270 pushed out through the nozzle 712 may be outputted as the target material 271 in the form of droplets by electrostatic force.

The target sensor 4 may be configured to detect the target material 271 and obtain information indicating the position, the speed, the size, the travel direction, the cycle, and/or the timing at which the target material 271 passes through at a predetermined position, and the stability thereof. Obtained information may then be sent to the EUV light generation controller 5 through the target controller 80 in the form of signals. For example, the EUV light generation controller 5 may receive a signal indicating a timing at which the target material 271 passes through a predetermined position. Then, the EUV light generation controller 5 may input an oscillation trigger of the pulse laser beam 31 to the laser apparatus 3 such that the target material 271 is irradiated with the pulse laser beam 33 in the plasma generation region 25. Upon being irradiated with the pulse laser beam 33, the target material 271 may be turned into plasma.

The target material 271 that is not irradiated with the pulse laser beam 33 may reach the liquid surface 274 of the target material 273 in the collection container 91. Since the target material 271 reaches the liquid surface 274 of the liquid target material 273, instead of a surface of a solid target material, the target material 271 may taken into the target material 273 without solidifying dendritically.

When the target material 271 continues to be collected into the collection container 91, a fluid level of the target material 273 may gradually increase. When the liquid surface 274 of the target material 273 exceeds the lower edge of the opening 916, as indicated by a dot-dashed line in FIG. 4, the target material 273 may flow out of the collection container 91 through the through-hole 915 and into the internal space 943 of the connection pipe 940. Since the wall of the internal space 943 is heated to a temperature that is equal to or higher than the melting point of the target material 273, the liquid target material 273 that has flowed into the internal space 943 may remain in a liquid state and flow into the collection tank 930. At this point, the liquid target material 275 may be stored in the collection tank 930. Therefore, the target material 273 may reach the liquid surface 276 of the target material 275 and be taken into the target material 275 without solidifying.

With the above-described configuration, a depth of the target material 273 stored in the collection container 91 may not exceed the distance D. In this way, the capacity adjuster 93 may allow the target material 273 to be discharged from the collection container 91 such that a fluid level of the target material 273 is retained within a predetermined range.

Further, since the target collection device 9 may be configured to discharge the target material 273 from the collection container 91, even when the EUV light generation apparatus 1 is put in operation for a long period of time, the target material 273 may be prevented from flowing over the collection container 91 inside the chamber 2. Since the target material 273 is discharged without carrying out any physical control in particular, the configuration of the target collection device 9 may be simplified.

Since the covering 92 which is frustoconical in shape is connected to the periphery of the opening 913, even when a splash is generated when the target material 271 reaches the liquid surface 274, the splash may not get out of the collection container 91.

Since the pipe heater 953 may heat the connection pipe 940 to a temperature that is equal to or higher than the melting point of the target material 273, the target material 273 discharged from the collection container 91 may flow through the connection pipe 940 in a liquid state and be collected into the collection tank 930.

Here, when the covering heater 957 is provided, the covering 92 may be formed of a material that has low wettability with the target material 271. With this configuration, a splash generated when the target material 271 reaches the liquid surface 274 may not deposit onto the covering 92 when it makes contact with the covering 92, and may flow along the covering 92 to be collected into the collection container 91.

Here, when the EUV light generation system 11 is test-driven, the target material 271 may be outputted from the target generation unit 70 while the pulse laser beam 31 is not outputted from the laser apparatus 3. Even in this case, the target control device 9 may be operated as described above.

### 3.2 Second Embodiment

### 3.2.1 Configuration

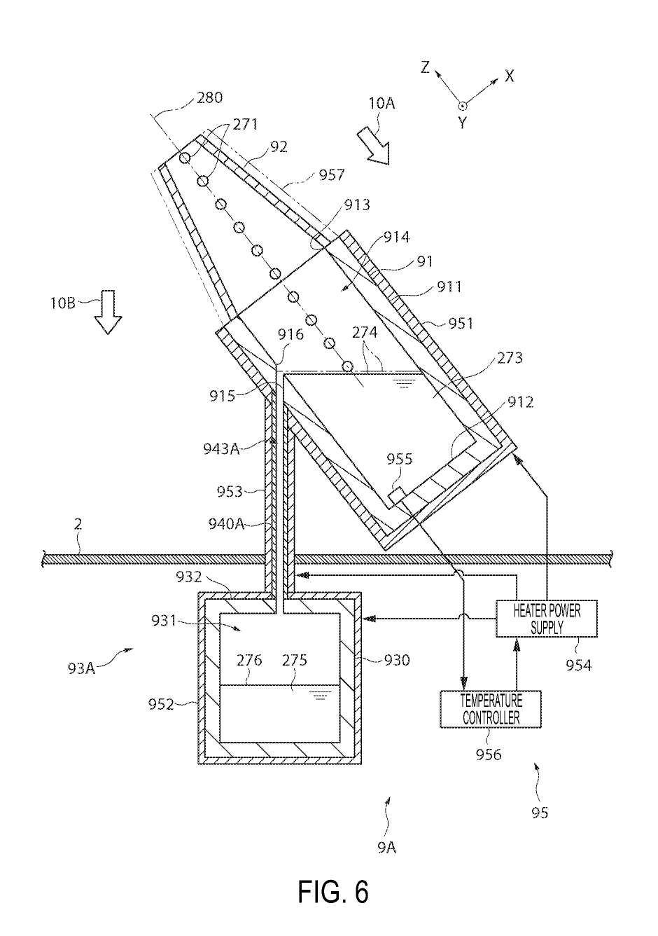

FIG. 6 schematically illustrates an exemplary configuration of a target collection device according to a second embodiment. In an EUV light generation apparatus of the second embodiment, the set output direction 10A is inclined with respect to the gravitational direction 10B.

As shown in FIG. 6, a target collection device 9A may include the collection container 91, the covering 92, a capacity adjuster 93A, and the second temperature adjuster 95. In the target collection device 9A, the collection container 91 may be provided inside the chamber 2 such that the axis of the side wall 911 is inclined with respect to the gravitational direction 10B and coincides with the trajectory 280 of the target material 271.

The capacity adjuster 93A may include the collection tank 930 and a connection pipe 940A serving as a discharge pipe. The connection pipe 940A may have an internal space 943A. The connection pipe 940A may be provided to extend from the periphery of the through-hole 915 to the upper surface 932 of the collection tank 930.

### 3.2.2 Operation

An operation of the EUV light generation apparatus 1 of the second embodiment may be similar to that of the first embodiment. When the processing as shown in the flowchart in FIG. 5 is carried out by the EUV light generation apparatus 1, a temperature of the target material 273 in the collection container 91, a temperature of the target material 275 in the collection tank 930, and a temperature inside the connection pipe 940 may rise to a temperature that is equal to or higher than the melting point of the target material 273/275. Then, the target material 273 and the target material 275 may remain in a liquid state to respectively form the liquid surface 274 and the liquid surface 276. Accordingly, as shown in FIG. 6, the target material 271 may reach the liquid surface 274 and be taken into the target material 273 without solidifying dendritically.

Further, when the liquid surface 274 exceeds the lower edge of the opening 916, as indicated by a dot-dashed line in FIG. 6, the target material 273 may flow out of the collection container through the through-hole 915 and into the collection tank 930 through the internal space 943A of the connection pipe 940A. Since the liquid target material 275 is stored in the collection tank 930, the target material 273 may reach the liquid surface 276 of the target material 275 in a liquid state and be taken into the target material 275 without solidifying dendritically.

In this way, since the target material 273 that has exceeded the lower edge of the opening 916 may flow into the collection tank 930, a fluid level of the target material 273 in the collection container 91 may be retained within a predetermined range.

### 3.3 Third Embodiment

### 3.3.1 Configuration

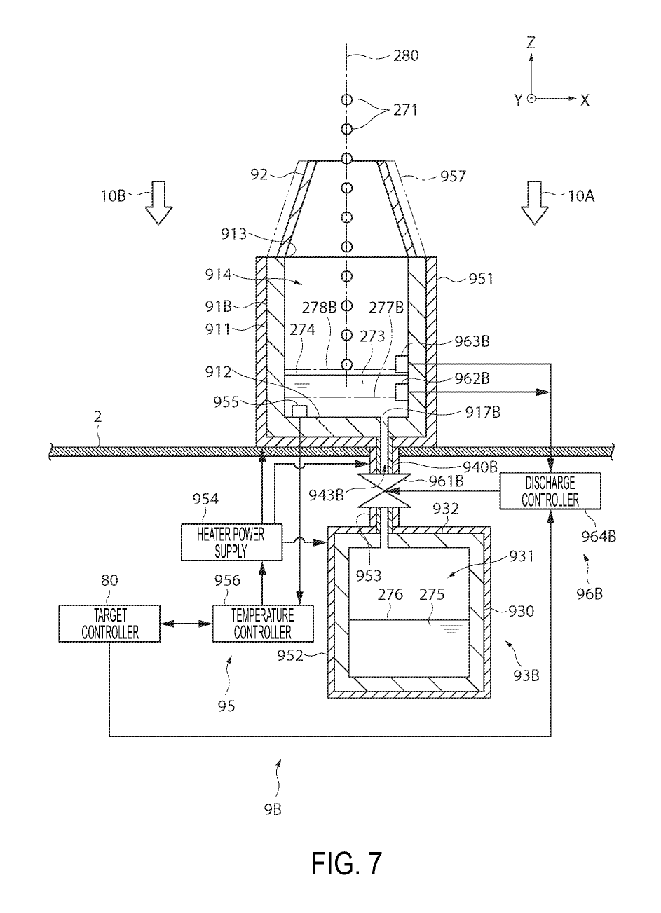

FIG. 7 schematically illustrates an exemplary configuration of a target collection device according to a third embodiment. As shown in FIG. 7, a target collection device 9B may include a collection container 91B, the covering 92, a capacity adjuster 93B, the second temperature adjuster 95, and a fluid level controller 96B.

The collection container 91B may include the cylindrical side wall 911 and the bottom 912 as in the collection container 91 of the first embodiment, but the bottom 912 may have a through-hole 917B formed therein.

The capacity adjuster 93B may include the collection tank 930 and a connection pipe 940B serving as a discharge pipe. The connection pipe 940B may have an internal space 943B. The connection pipe 940B may be provided to extend from the periphery of the through-hole 917B to the upper surface 932 of the collection tank 930.

The fluid level controller 96B may include a valve 961B serving as a flow rate adjuster, a first fluid level sensor 962B serving as a lower limit detector, a second fluid level sensor 963B serving as an upper limit detector, and a discharge controller 964B.

The valve 961B may be electrically connected to the discharge controller 964B. The valve 961B may be configured to switch between an open state and a closed state under the control of the discharge controller 964B. In an open state, the target material 273 in the internal space 914 may flow into the internal space 931. In a closed state, the target material 273 may not flow into the internal space 931.

The first fluid level sensor 962B and the second fluid level sensor 963B may be provided on the inner surface of the side wall 911. The discharge controller 964B may be electrically connected to each of the first fluid level sensor 962B and the second fluid level sensor 963B. The first fluid level sensor 962B may be provided below the second fluid level sensor 963B in the gravitational direction 10B. The first fluid level sensor 962B may be configured to detect the liquid surface 274 reaching a fluid level lower limit 277B, and send a lower limit signal indicating the aforementioned detection to the discharge controller 964B. The liquid surface 274 may reach the fluid level lower limit 277B as the target material 273 flows into the collection tank 930 and a fluid level of the target material 273 decreases.

The second fluid level sensor 962B may be configured to detect the liquid surface 274 reaching a fluid level upper limit 278B, and send an upper limit signal indicating the aforementioned detection to the discharge controller 964B. The liquid surface 274 may reach the fluid level upper limit 278B as the target material 271 is collected into the collection tank 91B and a fluid level of the target material 273 rises.

The discharge controller 964B may be electrically connected to the target controller 80. When the discharge controller 964B determines that the liquid surface 274 has reached the fluid level upper limit 278B based on an upper limit signal from the second fluid level sensor 963B, the discharge controller 964B may open the valve 961B so that the target material 273 in the collection container 91B flows into the collection tank 930. When the discharge controller 964B determines that the liquid surface 274 has reached the fluid level lower limit 277B based on a lower limit signal from the first fluid level sensor 962B, the discharge controller 964B may close the valve 961B so that the target material 273 in the collection container 91B stops flowing out of the collection container 91B.

### 3.3.2 Operation

The EUV light generation apparatus 1 may carry out processing similar to that shown in the flowchart in FIG. 5. Then, a temperature of the target material 273 in the collection container 91B, a temperature of the target material 275 in the collection tank 930, and a temperature inside the connection pipe 940B may rise to a temperature that is equal to or higher than the melting point of the target material 273/275. Then, the target material 273 and the target material 275 may melt, and the liquid surface 274 and the liquid surface 276 may be formed, respectively. Accordingly, as shown in FIG. 7, the droplet-shaped target material 271 may reach the liquid surface 274 in a liquid state and be taken into the target material 273 without solidifying dendritically.

When the liquid surface 274 in the collection container 91B rises to reach the fluid level upper limit 278B, the discharge controller 964B may open the valve 961B. Then, the target material 273 may flow into the collection tank 930. When the liquid surface 274 in the collection container 91B falls to reach the fluid level lower limit 277B, the discharge controller 964B may close the valve 961B. Then, the target material 273 may stop flowing out of the collection container 91B. With the above-described control, a fluid level of the target material 273 in the collection container 91B may be retained within a predetermined range.

Further, by adjusting the position of the first fluid level sensor 962B and/or the second fluid level sensor 963B, the amount of the target material 273 to be stored in the collection container 91B may be adjusted appropriately in accordance with the specifications of the EUV light generation apparatus 1.

Here, without providing the second fluid level sensor 963B, the target material 273 may start being discharged by the discharge controller 964B when a predetermined time elapses after the EUV light starts to be generated, assuming that the liquid surface 274 has reached the fluid level upper limit 278B. Alternatively, without providing the first fluid level sensor 962B, the target material 273 may stop being discharged by the discharge controller 964B when a predetermined time elapses after the target material 273 starts to be discharged, assuming that the liquid surface 274 has reached the fluid level lower limit 277B.

Further alternatively, without providing the valve 961B, flow of the target material from the collection container 91B into the collection tank 930 may be regulated by adjusting a temperature of the connection pipe 940B. When the connection pipe 940B is heated by the pipe heater 953, the target material 273 may be discharged from the collection container 91 in a liquid state through the connection pipe 940B. On the other hand, when the connection pipe 940B stops being heated by the pipe heater 953, a temperature of the connection pipe 940B may fall to a temperature that is lower than the melting point of the target material 273. Then, the target material 273 flowing from the collection container 91B may be solidified in the connection pipe 940B. Accordingly, the target material 273 may be prevented from flowing into the collection tank 930 through the connection pipe 940B.

### 3.4 Fourth Embodiment

### 3.4.1 Configuration

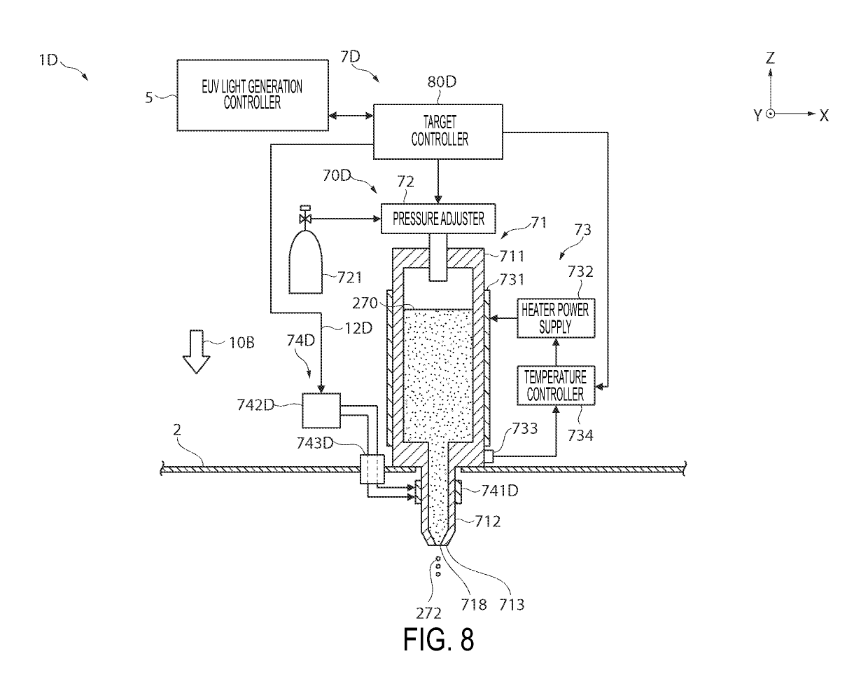

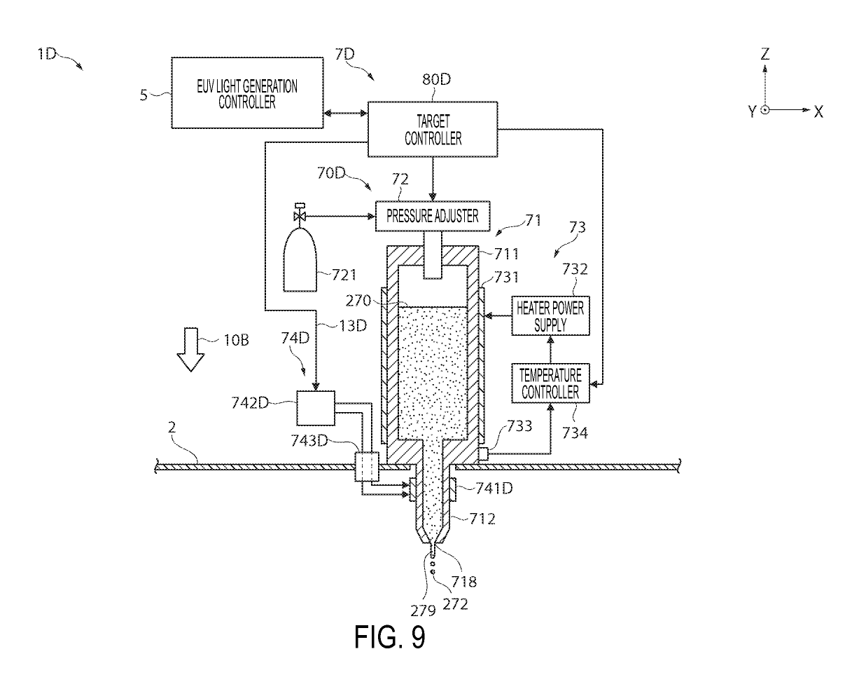

FIG. 8 schematically illustrates an exemplary configuration of a part of an EUV light generation apparatus according to a fourth embodiment, in which droplets are generated on-demand. FIG. 9 schematically illustrates an exemplary configuration of a part of the EUV light generation apparatus according to the fourth embodiment, in which droplets are generated in a continuous-jet method.

An EUV light generation apparatus 1D may include the chamber 2 and a target supply device 7D. Although not separately shown in FIG. 8, the EUV light generation apparatus 1D may further include the target collection device 9. A target generation unit 70D of the target supply device 7D may include the target generator 71, the pressure adjuster 72, the first temperature adjuster 73, and a piezoelectric pressurization unit 74D.

The piezoelectric pressurization unit 74D may include a piezoelectric element 741D and a piezoelectric element power supply 742D. The piezoelectric element 741D may be provided on the outer surface of the nozzle 712. In place of the piezoelectric element 741D, an element capable of applying a pressure on the nozzle 712 at high speed may be provided. The piezoelectric element power supply 742D may be electrically connected to the piezoelectric element 741A through a second introduction terminal 743D provided in the wall of the chamber 2. The piezoelectric element power supply 742D may be electrically connected to a target controller 80D. The target controller 80D may be electrically connected to each of the EUV light generation controller 5, the pressure adjuster 72, and the first temperature controller 734.

### 3.4.2 Operation

When the EUV light is to be generated, the target controller 80D may send a signal to the pressure adjuster 72 to adjust a pressure inside the tank 711 to a predetermined pressure. This predetermined pressure may be a pressure at which the target material 270 is pushed out through the nozzle opening 718 and a meniscus of the target material 270 is formed at the nozzle opening 718. In this state, a droplet 272 may not be outputted.

Then, the target controller 80D may send a droplet generation signal 12D to the piezoelectric element power supply 742D to generate the droplet 272 on-demand. Upon receiving the droplet generation signal 12D, the piezoelectric element power supply 742D may supply predetermined pulsed electric power to the piezoelectric element 741D. Upon being supplied with electric power, the piezoelectric element 741D may deform in accordance with the pulse shape of the electric power. With this, the nozzle 712 may be pressurized at high speed, and the droplets 272 may be outputted. When a pressure inside the tank 711 is retained at a predetermined pressure, the droplets 272 may be outputted in accordance with the pulse shape of the electric power.

Alternatively, the target controller 80D may be configured to generate the droplets 272 from a jet 279 in a continuous-jet method by adjusting a pressure inside the tank 711 accordingly, as shown in FIG. 9. In the continuous-jet method, a pressure inside the tank 711 may be set higher than the aforementioned predetermined pressure. Alternatively, the target controller 80D may be configured to send a vibration signal 13D to the piezoelectric element power supply 742D to generate the droplets 272.

Upon receiving the vibration signal 13D, the piezoelectric element power supply 742D may supply electric power to the piezoelectric element 741D to cause the piezoelectric element 741D to deform. Then, the piezoelectric element 741D may cause the nozzle 712 to vibrate at high speed. A displacement amount given to the nozzle 712 by the piezoelectric element 741D may be smaller compared to that in the above-described on-demand method. Through this operation, the jet 279 may be divided at a constant cycle, and the droplets 272 may be generated from the jet 279. The droplet 272 may then be irradiated with the pulse laser beam 33 (see FIG. 2).

In order to collect the droplets 272 that are not irradiated with the pulse laser beam 33, any of the target collection devices 9, 9A, and 9B described above and the corresponding method may be adopted.

### 3.5 Fifth Embodiment

### 3.5.1 Configuration

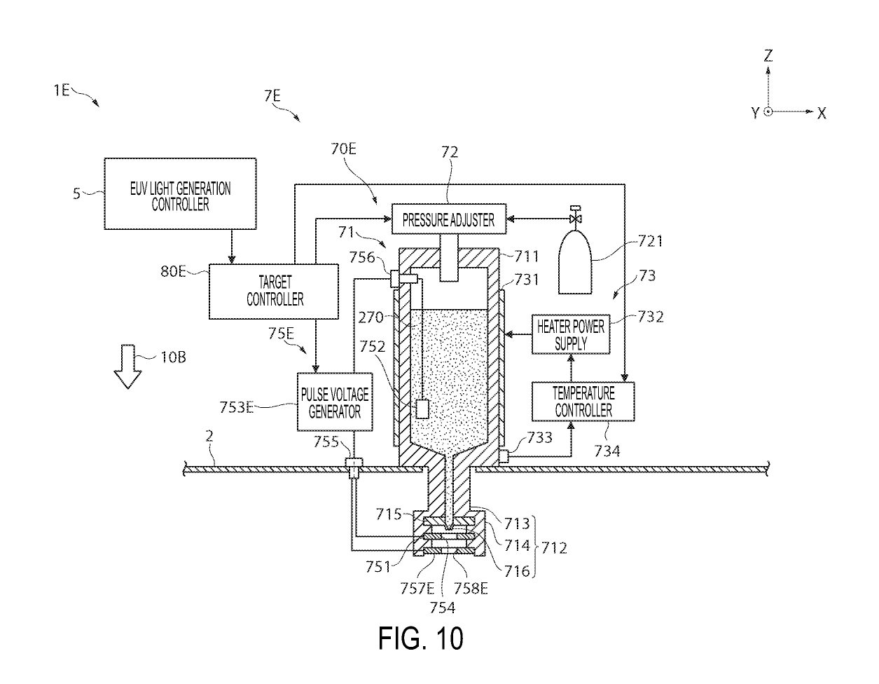

FIG. 10 schematically illustrates an exemplary configuration of a part of an EUV light generation apparatus according to a fifth embodiment. An EUV light generation apparatus 1E may include the chamber 2 and a target supply device 7E. Although not separately shown in FIG. 10, the EUV light generation apparatus 1E may further include the target collection device 9.

A target generation unit 70E of the target supply device 7E may include an electrostatic pull-out unit 75E. The electrostatic pull-out unit 75E may include the pull-out electrode 751, the electrode 752, a pulse voltage generator 753E, and an acceleration electrode 757E. The electrode 752 may be electrically connected to the pulse voltage generator 753E through the feedthrough 756. The acceleration electrode 757E may be substantially disc-shaped and may be in substantially the same size as the pull-out electrode 751. The acceleration electrode 757E may have a circular through-hole 758E formed at the center thereof, which is substantially the same size as the through-hole 754 in the pull-out electrode 751. The acceleration electrode 757E may be held by the holding unit 714 such that a space is secured between the acceleration electrode 757E and the pull-out electrode 751. The acceleration electrode 757E may be positioned such that the axis of the through-hole 758 coincides with the axis of the through-hole 754 and with the axis of the frustoconical protrusion 716. Each of the pull-out electrode 751 and the acceleration electrode 757E may be electrically connected to the pulse voltage generator 753E through the first introduction terminal 755.

The pulse voltage generator 753E may be configured to apply a positive potential to the target material 270 in the tank 711 through the electrode 752 and a negative potential to each of the pull-out electrode 751 and the acceleration electrode 757E. As the aforementioned potentials are applied to the respective electrodes 751, 752, and 757E, the target material 270 may be pulled out through the nozzle 712 in the form of droplets due to electrostatic force. The pulse voltage generator 753E may be electrically connected to a target controller 80E. The target controller 80E may be electrically connected to each of the EUV light generation controller 5, the pressure adjuster 72, and the first temperature controller 734.

In order to collect the target material 270 that is not irradiated with the pulse laser beam 33, any of the target collection devices 9, 9A, and 9B described above and the corresponding method may be adopted.

### 3.6 Sixth Embodiment

### 3.6.1 Configuration

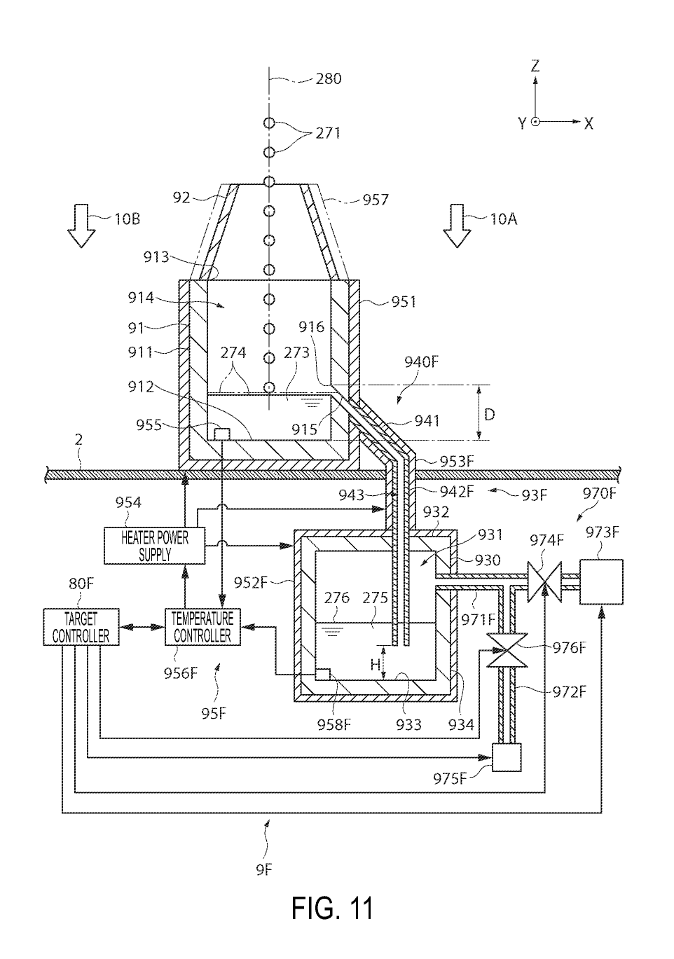

FIG. 11 schematically illustrates an exemplary configuration of a target collection device according to a sixth embodiment. As shown in FIG. 11, a target collection device 9F may be similar in configuration to the target collection device 9 of the first embodiment, but may differ in that a capacity adjuster 93F serving also as a supply unit is provided in place of the capacity adjuster 93. The target collection device 9F may further include a second temperature adjuster 95F.

The capacity adjuster 93F may be configured to discharge the target material 273 from the collection container 91 so that a fluid level of the target material 273 in the collection container 91 is retained within a predetermined range. Further, the capacity adjuster 93F may be configured to supply the target material 273 into the collection container 91. The capacity adjuster 93F may include the collection tank 930, a connection pipe 940F serving both as a discharge pipe and as a supply pipe, and a supply amount adjuster 970F.

The connection pipe 940F may include the first pipe 941 and a second pipe 942F extending from the first pipe 941. The second pipe 942F may be provided to penetrate the upper surface 932 of the collection tank 930 and extend toward the vicinity of a bottom 933 of the collection tank 930. More specifically, the second pipe 942F may be formed such that a distance between a leading end of the second pipe 942F and the bottom 933 of the collection tank 930 is at a distance H.

The supply amount adjuster 970F may include an exhaust pipe 971F, an air-supply pipe 972F, an exhaust pump 973F, an exhaust valve 974F, an air-supply unit 975F, and an air-supply valve 976F. The exhaust pipe 971F may be connected to an upper part of a side wall 934 of the collection tank 930. The air-supply pipe 972F may be connected to substantially the middle of the exhaust pipe 971F to extend perpendicularly therefrom. A target controller 80F may be electrically connected to each of the exhaust pump 973F, the exhaust valve 974F, the air-supply unit 975F, and the air-supply valve 976F. The exhaust pump 973F may be provided at a leading end of the exhaust pipe 971F to allow gas inside the collection tank 930 to be discharged. The exhaust valve 974F may be provided on the exhaust pipe 971F between the exhaust pump 973F and the connection part of the exhaust pipe 971F and the air-supply pipe 972F. The exhaust valve 974F may be configured to switch between an open state and a closed state under the control of the target controller 80F. The air-supply unit 975F may be provided at a leading end of the air-supply pipe 972F and configured to supply gas into the collection tank 930 through the air-supply pipe 972F. The air-supply unit 975F may supply an inert gas, such as nitrogen gas, into the collection tank 930. The air-supply valve 976F may be provided on the air-supply pipe 972F. The air-supply valve 976F may be configured to switch between an open state and a closed state under the control of the target controller 80F.

The second temperature adjuster 95F may include the container heater 951, a tank heater 952F serving as a supply material temperature adjuster, a pipe heater 953F serving both as a pipe temperature adjuster and as a supply material temperature adjuster, the second heater power supply 954, the second temperature sensor 955, a third temperature sensor 958F, and a second temperature controller 956F.

The second heater power supply 954 may be electrically connected to each of the container heater 951, the tank heater 952F, and the pipe heater 953F. The second temperature controller 956F may be electrically connected to each of the second heater power supply 954, the second temperature sensor 955, the third temperature sensor 958F, and the target controller 80F.

The tank heater 952F may be provided to cover the outer surface of the collection tank 930. The pipe heater 953F may be provided to cover the outer surface of the first pipe 941 and a part of the outer surface of the second pipe 942F located outside the collection tank 930. The third temperature sensor 958F may be provided on the bottom 933 of the collection tank 930. The third temperature sensor 958F may be configured to detect a temperature of the target material 275 in the collection tank 930, and send a signal corresponding to a detected temperature to the second temperature controller 956F.

### 3.6.2 Operation

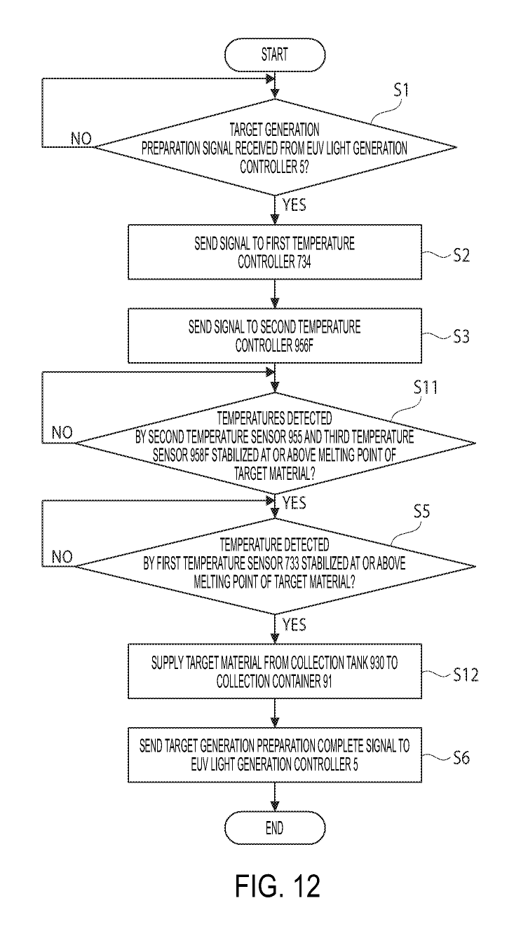

FIG. 12 is a flowchart showing an exemplary operation of an EUV light generation apparatus in a case where a solid target material is not present in a collection container but is present in advance in a collection tank. Here, an operation in a case where a solid target material is present in the collection container may be similar to that of the first embodiment, and the description thereof will be omitted.

In a state where a pressure inside the chamber 2 is adjusted to a pressure at which EUV light may be generated, the target controller 80F may carry out processing similar to that in Steps S1 and S2 of FIG. 5, as shown in FIG. 12.

Then, the second temperature controller 956F may control electric power to be supplied to the container heater 951 and to the pipe heater 953F, respectively, based on a signal from the second temperature sensor 955 so that a temperature inside the collection container 91 and a temperature inside the connection pipe 940F reach or exceed the melting point of the target material 273. Further, the second temperature controller 956F may control electric power to be supplied to the tank heater 952F based on a signal from the third temperature sensor 958F so that a temperature of the target material in the collection tank 930 reaches or exceeds the melting point of the target material 275 (Step S3).

When the collection tank 930 in which the solid target material 275 is present is heated in this way, the target material 275 in the collection tank 930 may melt. In addition, since the empty collection container 91 and the connection pipe 940F are heated as described above, the liquid target material 275 may be prevented from solidifying when the liquid target material 275 is supplied from the collection tank 930 into the collection container 91.

The target controller 80F may determine whether or not a temperature detected by the second temperature sensor 955 and a temperature detected by the third temperature sensor 958F are stabilized at a temperature that is equal to or higher than the melting point of the target material 273/275 based on a signal from the second temperature controller 956F (Step S11). When detected temperatures are determined not be stabilized (Step S11; NO), Step S11 may be repeated. On the other hand, when the target controller 80F determines that the detected temperatures are stabilized (Step S11; YES), the target controller 80F may carry out the processing in Step S5, which may be similar that in Step 5 of FIG. 5, and then supply the liquid target material 275 from the collection tank 930 into the empty collection container 91 (Step S12).

More specifically, in Step S12, the target controller 80F may close the exhaust valve 974F and open the air-supply valve 976F. Then, the target controller 80F may actuate the air-supply unit 975F to supply gas into the collection tank 930. When gas is supplied into the collection tank 930, a pressure applied on the liquid surface 276 of the target material 275 in the collection tank 930 may increase. Here, since the chamber 2 is kept at a low pressure, the collection container 91 may also be at a low pressure. With this pressure difference between the internal space 914 of the collection container 91 and the internal space 931 of the collection tank 930, the target material 275 in the collection tank 930 may be supplied into the collection container 91 through the connection pipe 940F. Thus, the target material 273 may be stored in the collection container 91, and the liquid surface 274 may be formed in the collection container 91.

The target controller 80F may stop the air-supply unit 975F and close the air-supply valve 976F after a predetermined time elapses after the air-supply unit 975F is actuated. Then, the target controller 80F may open the exhaust valve 974F and actuate the exhaust pump 973F for a predetermined time to discharge gas in the collection tank 930. When gas in the collection tank 930 is discharged, the target material 275 may stop being supplied into the collection container 91.

When the processing in Step S12 has been completed, the target controller 80F may send a target generation preparation complete signal to the EUV light generation controller 5 (Step S6).

As described above, when the target material 273 is not present in the collection container 91 prior to generating EUV light, the target collection device 9F may supply the target material 275 from the collection tank 930 into the collection container 91 so that the liquid surface 274 of the target material 273 is formed. Thus, the target material 271 outputted through the nozzle 712 may reach the liquid surface 274 in a liquid state and be taken into the target material 273 without solidifying dendritically in the collection container 91.

When a fluid level of the target material 273 in the collection container 91 exceeds a predetermined level, the target material 273 may be discharged into the collection tank 930, as in the first embodiment described above.

According to the sixth embodiment, since the single connection pipe 940F is used to discharge the target material 273 from the collection container 91 into the collection tank 930 and to supply the target material 275 from the collection tank 930 into the collection container 91, the number of pipe(s) penetrating the chamber 2 may be minimized.

Alternatively, aside from the connection pipe 940F, a pipe, such as the connection pipe 940 shown in FIG. 4, used solely to discharge the target material 273 from the collection container 91 into the collection tank 930 may be provided.

### 3.7 Seventh Embodiment

### 3.7.1 Configuration

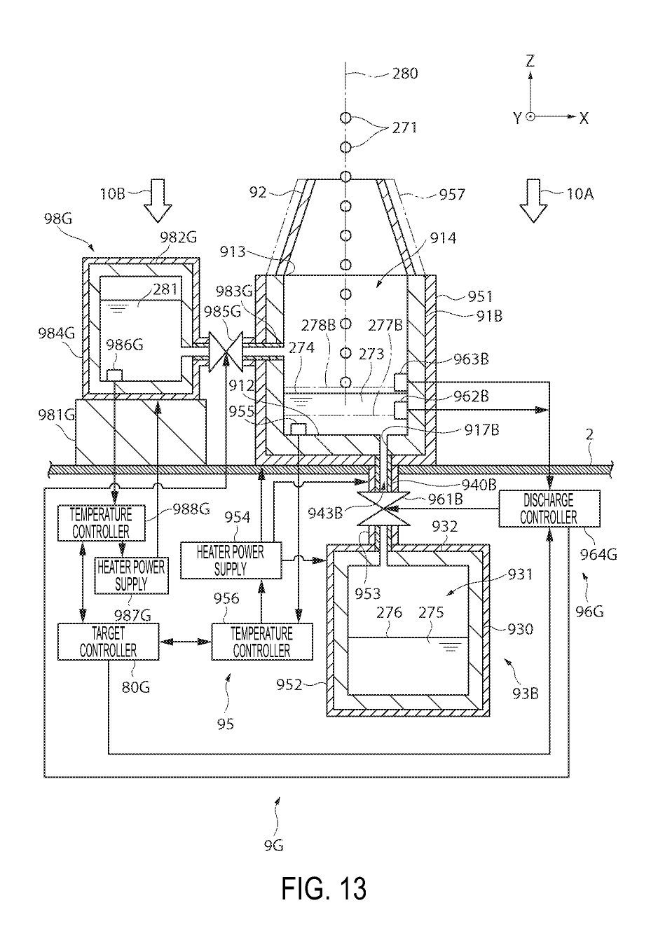

FIG. 13 schematically illustrates an exemplary configuration of a target collection device according to a seventh embodiment. As shown in FIG. 13, a target collection device 9G may include the collection container 91B, the capacity adjuster 93B, the second temperature adjuster 95, a fluid level controller 96G, and a supply unit 98G. The configuration and the operation of the capacity adjuster 93B may be similar to those of the third embodiment, and the duplicate description thereof will be omitted.

The supply unit 98G may include a stage 981G, a supply tank 982G, a supply pipe 983G, a tank heater 984G, a supply valve 985G, a fourth temperature sensor 986G, a fourth heater power supply 987G, and a fourth temperature controller 988G. The stage 981G may be provided inside the chamber 2 adjacent to the collection container 91B. The supply tank 982G may be box-shaped, and may be mounted on the stage 981G. The supply pipe 983G may be provided to connect the supply tank 982G at a lower side thereof to the collection container 91B. The connection part of the supply pipe 983G and the collection container 91B may be set higher than the fluid level upper limit 278B.

The tank heater 984G may be provided to cover the outer surface of the supply tank 982G and the outer surface of the supply pipe 983G. The supply valve 985G may be provided on the supply pipe 983G. The supply valve 985G may be electrically connected to a discharge controller 964G. The supply valve 985G may be configured to switch between an open state and a closed state under the control of the discharge controller 964G.

The fourth temperature sensor 986G may be provided on the bottom of the supply tank 982G. The fourth temperature sensor 986G may be electrically connected to the fourth temperature controller 988G. The fourth temperature sensor 986G may be configured to detect a temperature of a target material 281 in the supply tank 982G, and send a signal corresponding to a detected temperature to the fourth temperature controller 988G.

The fourth heater power supply 987G may be electrically connected to each of the tank heater 984G and the fourth temperature controller 988G. The fourth heater power supply 987G may be configured to supply electric power to the tank heater 984G based on a signal from the fourth temperature controller 988G so that the tank heater 984G emits heat. Thus, the target material 281 in the supply tank 982G may be heated.

The fourth temperature controller 988G may be electrically connected to a target controller 80G. The fourth temperature controller 988G may determine a temperature of the target material 281 based on a signal from the fourth temperature sensor 986G, and output a signal to the tank heater 984G to adjust a temperature of the target material 281 to a predetermined temperature. The target controller 80G may be electrically connected to each of the second temperature controller 956 and the discharge controller 964G.

### 3.7.2 Operation

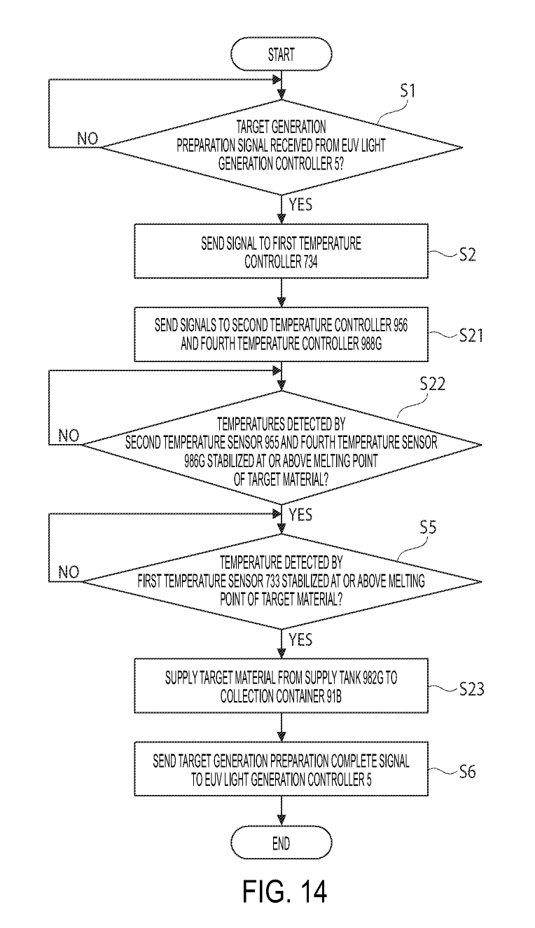

FIG. 14 is a flowchart showing an exemplary operation of an EUV light generation apparatus in a case where a solid target material is not present in a collection container but is present in advance in a supply tank. An operation in a case where a solid target material is present in the collection container may be similar to that of the third embodiment, and the duplicate description thereof will be omitted.

In a state where a pressure inside the chamber 2 is adjusted to a pressure at which EUV light may be generated, the target controller 80G may carry out the processing in Steps S1 and S2 of FIG. 14, which are similar to Steps S1 and S2 of FIG. 5. Then, the target controller 80G may send signals respectively to the second temperature controller 956 and the fourth temperature controller 988G (Step S21). Based on these signals, the second heater power supply 954 may control the container heater 951 and the tank heater 952, and the fourth heater power supply 987G may control the tank heater 984G. Accordingly, a temperature of the collection container 91B, a temperature of the collection tank 930, and a temperature of the supply tank 982G may rise to a temperature that is equal to or higher than the melting point of the target material 281.

When the supply tank 982G in which the solid target material 281 is present is heated in this way, the target material 281 in the supply tank 982G may melt. Further, since the empty collection container 91B and the supply pipe 983G are heated as described above, the target material 281 may be prevented from solidifying when the liquid target material 281 is supplied from the supply tank 982G into the collection container 91B.

The target controller 80G may then determine whether or not a temperature detected by the second temperature sensor 955 and a temperature detected by the fourth temperature sensor 986G are stabilized at a temperature that is equal to or higher than the melting point of the target material 281 based on respective signals from the second temperature controller 956 and the fourth temperature controller 988G (Step S22). When the detected temperatures are determined not to be stabilized (Step S22; NO), Step S22 may be repeated.

On the other hand, when the target controller 80G determines that the detected temperatures are stabilized (Step S22; YES), the target controller 80G may carry out the processing in Step S5, which may be similar to Step S5 of FIG. 5, and then supply the liquid target material 281 into the empty collection container 91B (Step S23).

More specifically, in Step S23, the target controller 80G may send a signal to the discharge controller 964G. Upon receiving a signal, the discharge controller 964G may close the valve 961B and open the supply valve 985G. When the supply valve 985G is open, the target material 281 in the supply tank 982G may be supplied into the collection container 91B through the supply pipe 983G by the gravitational force. Accordingly, the liquid surface 274 of the target material 273 may be formed in the collection container 91B. Thereafter, when the second fluid level sensor 963B detects the liquid surface 274 reaching the fluid level upper limit 278B, the second fluid level sensor 963B may send an upper limit signal to the discharge controller 964G. Upon receiving an upper limit signal, the discharge controller 964G may close the supply valve 985G to stop supplying the target material 281 into the collection container 91B.

When the processing in Step S23 has been completed, the target controller 80G may send a target generation preparation complete signal to the EUV light generation controller 5 (Step S6).

As described above, when the target material 273 is not present in the collection container 91 prior to generating EUV light, the target collection device 9G may supply the target material 281 from the supply tank 982G into the collection container 91B so that the liquid surface 274 of the target material 273 is formed in the collection container 91B. Thus, the target material 271 outputted through the nozzle 712 may reach the liquid surface 274 in a liquid state and be taken into the target material 273 without solidifying dendritically in the collection container 91B.

The above-described embodiments and the modifications thereof are merely examples for implementing this disclosure, and this disclosure is not limited thereto. Making various modifications according to the specifications or the like is within the scope of this disclosure, and other various embodiments are possible within the scope of this disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as at least one or “one or more.”

What is claimed is:

1. A target collection device, comprising:
a collection container having an opening through which a target material is collected into the collection container; and
a temperature adjuster configured to adjust a temperature of the collection container to a temperature that is equal to or higher than a melting point of the target material.

2. The target collection device according to claim 1, further comprising a capacity adjuster configured to discharge the target material from the collection container so that a fluid level of the target material in the collection container is retained within a predetermined range.

3. The target collection device according to claim 2, wherein:
the collection container includes a side wall having a through-hole formed therein and a bottom;
the capacity adjuster includes a discharge pipe connected to the side wall of the collection container at a periphery of the through-hole; and
the temperature adjuster includes a pipe temperature adjuster configured to adjust a temperature of the discharge pipe to a temperature that is equal to or higher than the melting point of the target material.

4. The target collection device according to claim 2, further comprising a fluid level controller, wherein:
the collection container includes a side wall and a bottom having a through-hole formed therein;
the capacity adjuster includes a discharge pipe connected to the bottom of the collection container at a periphery of the through-hole;
the temperature adjuster includes a pipe temperature adjuster configured to adjust a temperature of the discharge pipe to a temperature that is equal to or higher than the melting point of the target material; and
the fluid level controller includes:
a flow rate adjuster configured to regulate a flow rate of the target material in the discharge pipe,
an upper limit detector configured to send an upper limit signal upon detecting a fluid level of the target material in the collection container exceeding a first predetermined level,
a lower limit detector configured to send a lower limit signal upon detecting a fluid level of the target material in the collection container reaching a second predetermine level, and
a discharge controller configured to control the flow rate adjuster upon receiving the upper limit signal to discharge the target material from the collection container and control the flow rate adjuster upon receiving the lower limit signal to stop a discharge of the target material from the collection container.

5. The target collection device according to claim 2, wherein the capacity adjuster further includes:
a collection tank into which the target material is discharged from the collection container; and
a supply amount adjuster configured to adjust an amount of the target material to be supplied into the collection container from the collection tank.

6. An extreme ultraviolet light generation apparatus, comprising:
a chamber in which extreme ultraviolet light is generated;
a target supply device configured to output a target material into the chamber; and
the target collection device of claim 1.

7. A target collection method, comprising:
forming a liquid surface of a target material in a collection container for collecting the target material; and
receiving the target material outputted from a target supply device at the liquid surface.

8. The target collection method according to claim 7, further comprising discharging the target material from the collection container so that a fluid level of the target material in the collection container is retained within a predetermined range.

9. The target collection method according to claim 8, wherein:
the target material is discharged from the collection container through a discharge pipe, and
a temperature of the discharge pipe is adjusted to a temperature that is equal to or higher than a melting point of the target material.

10. The target collection method according to claim 9, wherein:
a discharge port of the discharge pipe is provided at a predetermined depth in the collection container, and
the target material is discharged from the collection container through the discharge port when a fluid level of the target material exceed a predetermined level.

11. The target collection method according to claim 9, further comprising:
adjusting a flow rate of the target material in the discharge pipe;
detecting a fluid level of the target material exceeding the predetermined range; and
detecting a fluid level of the target material falling below a predetermined lower limit,
wherein
based on a detection of the fluid level exceeding the predetermined range, the flow rate of the target material is adjusted so that the target material is discharged, and
based on a detection of the fluid level falling below the predetermined lower limit, a discharge of the target material is stopped.

12. The target collection method according to claim 9, wherein the liquid surface is formed by supplying a target material from a container other than the target supply device into the collection container.

13. The target collection method according to claim 12, wherein:
the target material discharged from the collection container is stored in a collection tank,
the target material stored in the collection tank is supplied into the collection container through the discharge pipe, and
a temperature of the collection tank and a temperature of the discharge pipe are adjusted to a temperature that is equal to or higher than the melting point of the target material.
